(19) United States
(12) Patent Application Publication
(10) Pub. No.: US 2018/0310624 A1
(43) Pub. Date: Nov. 1, 2018

(54) CELLULOSE ACETATE FILM FOR AEROSOL-GENERATING DEVICE

(71) Applicant: CELANESE INTERNATIONAL CORPORATION, Irving, TX (US)

(72) Inventors: KEVIN PARKER, Hilton Derby (GB); Joanna MARSHALL, Lichfields Staffs (GB)

(21) Appl. No.: 15/966,161

(22) Filed: Apr. 30, 2018

Related U.S. Application Data
(60) Provisional application No. 62/491,364, filed on Apr. 28, 2017.

(51) Int. Cl. A24F 47/00; C08J 5/18

(52) U.S. Cl. CPC A24F 47/008; C08K 5/11; C08J 2301/12; C08J 5/18

(57) ABSTRACT

Disclosed are cellulose acetate films for use in an aerosol-generating device, such as an electrically heated cigarette. The cellulose acetate films comprise cellulose acetate and a plasticizer.

### CROSS REFERENCE TO RELATED APPLICATION

This application is a non-provisional of U.S. Provisional Application No. 62/491,364, filed on Apr. 28, 2017, the entire contents and disclosure of which is hereby incorporated by reference.

### FIELD OF THE INVENTION

The present invention relates generally to cellulose acetate films that are included as an aerosol-cooling element in an aerosol-generating device. In particular, the present invention relates to an aerosol-cooling element made from crimped cellulose acetate films comprising a plasticizer.

### BACKGROUND OF THE INVENTION

Cellulose esters, such as cellulose acetate, are known for their use in traditional cigarette filters and other smoking articles. Many factors affect cigarette filter production and performance. The cellulose ester, supplied to filter manufacturers as cellulose ester tow, is manufactured to meet certain properties required for cigarette filters, such as a firmness, pressure drop, pressure drop variability, fly, and openability. Methods of making cellulose ester tow continue to be refined to improve the properties of the tow for use in cigarette filters.

As health concerns over cigarette smoking continue, consumers are seeking alternate methods for nicotine delivery. Conventional cigarettes deliver nicotine by combusting tobacco, which also results in the inhalation of numerous harmful aerosol constituents by the user. One proposed alternative is to heat the tobacco rather than combust it, with the goal of reducing known harmful aerosol constituents of the type produced by the combustion and pyrolytic degradation of tobacco in conventional cigarettes. Cigarettes that heat the tobacco rather than combust it are referred to as heated cigarettes.

As explained in US Pub. No. 2015/0359264, there many different chemicals in conventional cigarette aerosol. Many of these chemicals are generated by the thermal decomposition, pyrolysis and/or incomplete combustion of tobacco at temperatures in excess of 300° C. Typically, in heated cigarettes, an aerosol is generated by the transfer of heat from a heat source to a physically separate aerosol-forming substrate or material, which may be located within, around or downstream of the heat source. During smoking, volatile compounds are released from the aerosol-forming substrate by heat transfer from the heat source and entrained in air drawn through the smoking article. As the released compounds cool, they condense to form an aerosol that is inhaled by the user.

US Pub No. 2015/0359264 describes a heated cigarette and suggests several materials for forming an aerosol-cooling element. The preferred material is polylactic acid.

The need exists for an aerosol-cooling element comprising cellulose acetate which is acceptable for use in an aerosol-generating device, such as a heated cigarette.

### SUMMARY OF THE INVENTION

In some aspects, the present invention is directed to an aerosol-generating device comprising: an aerosol-generating article, wherein the aerosol-generating article comprises: an aerosol-forming substrate, a support element; an aerosol-cooling element comprising a crimped cellulose acetate film; and a mouthpiece; wherein the cellulose acetate film comprises cellulose acetate and a plasticizer. The cellulose acetate film may have a thickness from 14 to 700 μm, from 14 to 150 μm, from 20 to 75 μm, or of less than 50 μm. The cellulose acetate film may further comprise a processing aid. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. The processing aid may be present from 0.05 to 10 wt. %, based on the total weight of the film. The plasticizer may be a food-grade plasticizer. The plasticizer may be selected from the group consisting of diacetin, tripropionin, trimethyl citrate, tributyl citrate, triethyl citrate, eugenol, cinnamyl alcohol, alkyl lactones, methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In some aspects, the plasticizer is triacetin. In some aspects, the plasticizer is phthalate-free. The cellulose acetate film may comprise from 0.5 to 40 wt. % plasticizer, or from 1 to 35 wt. % plasticizer, based on the total weight of the film. The cellulose acetate film may further comprise a releasing agent. In some aspects, the releasing agent is a fatty acid, such as stearic acid. The device may further comprise a heating element.

In another aspect, the present invention is directed to a method of forming an aerosol-generating article, the method comprising: (a) forming a cellulose acetate dope comprising cellulose acetate, a solvent, and a plasticizer; (b) casting the cellulose acetate dope and evaporating the solvent to form a cellulose acetate film; (c) crimping the cellulose acetate film to form an aerosol-cooling element; (d) aligning a mouthpiece, the aerosol-cooling element, a support element, and an aerosol-forming substrate; and (e) circumferentially wrapping an outer wrapper around the mouthpiece, the aerosol-cooling element, the support element, and the aerosol-forming substrate. The cellulose acetate film may have a thickness from 14 to 700 μm, from 14 to 150 μm, from 20 to 75 μm, or of less than 50 μm. The cellulose acetate film may further comprise a processing aid. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. The processing aid may be present from 0.05 to 10 wt. %, based on the total weight of the film. The plasticizer may be a food-grade plasticizer. The plasticizer may be selected from the group consisting of diacetin, tripropionin, trimethyl citrate, tributyl citrate, triethyl citrate, eugenol, cinnamyl alcohol, alkyl lactones, methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In some aspects, the plasticizer is triacetin. In some aspects, the plasticizer is phthalate-free. The cellulose acetate film may comprise from 0.5 to 40 wt. % plasticizer, or from 1 to 35 wt. % plasticizer, based on the total weight of the film. The cellulose acetate film may further comprise a releasing agent. In some aspects, the releasing agent is a fatty acid, such as stearic acid. The device may further comprise a heating element.

In yet another aspect, the present invention is directed to a method of forming an aerosol-generating article, the method comprising: (a) forming a mixture of cellulose acetate and plasticizer, wherein the mixture comprises from 20 to 40 wt. % plasticizer, based on the total weight of the mixture; (b) extruding the mixture at a temperature up to 230° C. to form a cellulose acetate pellet; (c) extruding the pellet to form a cellulose acetate film; (d) crimping the cellulose acetate film to form an aerosol-cooling element; (e) aligning a mouthpiece, the aerosol-cooling element, a support element, and an aerosol-forming substrate; and (f) circumferentially wrapping an outer wrapper around the mouthpiece, the aerosol-cooling element, the support element, and the aerosol-forming substrate. The cellulose acetate film may have a thickness from 14 to 700 μm, from 14 to 150 μm, from 20 to 75 μm, or of less than 50 μm. The cellulose acetate film may further comprise a processing aid. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. The processing aid may be present from 0.05 to 10 wt. %, based on the total weight of the film. The plasticizer may be a food-grade plasticizer. The plasticizer may be selected from the group consisting of diacetin, tripropionin, trimethyl citrate, tributyl citrate, triethyl citrate, eugenol, cinnamyl alcohol, alkyl lactones, methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In some aspects, the plasticizer is triacetin. In some aspects, the plasticizer is phthalate-free. The cellulose acetate film may comprise from 0.5 to 40 wt. % plasticizer, or from 1 to 35 wt. % plasticizer, based on the total weight of the film. The cellulose acetate film may further comprise a releasing agent. In some aspects, the releasing agent is a fatty acid, such as stearic acid. The device may further comprise a heating element.

### BRIEF DESCRIPTION OF THE DRAWINGS

The present invention will be better understood in view of the appended non-limiting figure, in which:

FIG. 1 shows a cross-sectional view of an aerosol-generating article in accordance with embodiments of the present invention; and

FIG. 2 shows a cross-sectional view of an aerosol-generating device comprising a heating element and the aerosol-generating article of FIG. 1, in accordance with embodiments of the present invention.

### DETAILED DESCRIPTION OF THE INVENTION

I. Introduction

The present disclosure is directed to aerosol-generating devices comprising a cellulose-acetate film as an aerosol-cooling element. The aerosol-generating device also comprises an aerosol-forming substrate, a support element, and a mouthpiece. The cellulose acetate film comprises cellulose acetate, a plasticizer, and optionally a processing aid, such as silica. The cellulose acetate film may be prepared by melt extruding or solvent casting, followed by crimping. If solvent cast, the film may also comprise a releasing agent, such as stearic acid. Advantageously, because cellulose acetate and certain plasticizers are already used in traditional cigarette filters, the materials are acceptable from a regulatory and safety standpoint for use in an aerosol-generating device. Additionally, as compared to an aerosol-generating component comprising polylactic acid, the cellulose acetate film may be thinner, have improved cooling properties, have greater surface area, and aid in reduction of harmful aerosol constituents.

II. Cellulose Acetate

As described herein, the present disclosure relates to a cellulose acetate film used as an aerosol-cooling element in an aerosol-generating device. Cellulose acetate, as used herein, refers to cellulose diacetate. In some aspects, the cellulose acetate has a degree of substitution from 2 to 2.6.

Cellulose acetate may be prepared by known processes, including those disclosed in U.S. Pat. No. 2,740,775 and in U.S. Publication No. 2013/0096297, the entireties of which are incorporated herein by reference. Typically, acetylated cellulose is prepared by reacting cellulose with an acetylating agent in the presence of a suitable acidic catalyst and then de-esterifying.

The cellulose may be sourced from a variety of materials, including cotton linters, a soft wood or from a hardwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods. In some aspects, a hardwood cellulose is preferred for acetylating.

Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high degree of substitution (DS) value, such as from 2.5 to 3, e.g., about 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C₁ to C₂₀ alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 2.9, e.g., from 1.5 to 2.9 or from 2 to 2.6. The degree of substitution may be selected based on the at least one organic solvent to be used in the binder composition. For example, when acetone is used as an organic solvent, the degree of substitution may range from 2.2 to 2.65.

The number average molecular weight of the cellulose acetate may range from 30,000 amu to 100,000 amu, e.g., from 50,000 amu to 80,000 amu and may have a polydispersity from 1.5 to 2.5, e.g., from 1.75 to 2.25 or from 1.8 to 2.2. All molecular weight recited herein, unless otherwise specified, are number average molecular weights. The molecular weight may be selected based on the desired hardness of the final wood filler composition. Although greater molecular weight leads to increased hardness, greater molecular weight also increases viscosity. The cellulose acetate may be provided in powder or flake form.

In some aspects, blends of different molecular weight cellulose acetate flake or powder may be used. Accordingly, a blend of high molecular weight cellulose acetate, e.g., a cellulose acetate having a molecular weight above 60,000 amu, may be blended with a low molecular weight cellulose acetate, e.g., a cellulose acetate having a molecular weight below 60,000 amu. The ratio of high molecular weight cellulose acetate to low molecular weight cellulose acetate may vary but may generally range from 1:10 to 10:1; e.g., from 1:5 to 5:1 or from 1:3 to 3:1.

III. Aerosol-Cooling Element Composition and Preparation Thereof

The cellulose acetate described herein may be prepared as a film and used as an aerosol-cooling element. Cellulose acetate cannot be processed as a raw material because its decomposition temperature is lower than melt-processing temperatures. One solution to this problem is to use plasticizers. Combining a plasticizer with cellulose acetate reduces interactions between segments of the cellulose acetate polymer chain and reduces the glass transition temperature, melt viscosity and elastic modulus of the cellulose acetate, making the plasticized cellulose acetate melt processable.

Generally, the cellulose acetate film comprises from 55 to 99.5 wt. % cellulose acetate, based on the total weight of the film, e.g., from 60 to 95 wt. %, from 65 to 90 wt. %, or from 70 to 85 wt. %. The cellulose acetate film also comprises a plasticizer and may comprise a processing aid, and/or a releasing agent. In some aspects, the cellulose acetate film may comprise a blend of cellulose acetate and polylactic acid.

The plasticizer maybe present from 0.5 to 40 wt. % based on the total weight of the film, e.g., from 1 to 35 wt. %, from 5 to 30 wt. %, or from 10 to 25 wt. %. The percentage of plasticizer may vary depending on the method by which the cellulose acetate film is formed. Generally, a greater weight percentage of plasticizer is used to form the film by melt extrusion as compared to solvent casting, e.g., from 15 to 40 wt. %, from 20 to 40 wt. %, or from 25 to 35 wt. % for melt extrusion and from 0.5 to 25 wt. %, e.g., from 1 to 25 wt. %, from 5 to 25 wt. %, or from 10 to 25 wt. % for solvent casting.

Various plasticizers may be used to reduce the glass transition temperature of cellulose acetate. Manufacturers of cellulose acetate may choose the type and amount of plasticizer (e.g., the ratio of plasticizer to cellulose acetate) based on a number of factors including the desired properties of a final composition and/or chosen for compatibility with other components of a final composition. For example, some types of plasticizers may be selected because they are biodegradable, allowing for the plasticized cellulose acetate to be eco-friendly. The amount of plasticizer may be chosen to: (i) reduce the glass transition temperature of the cellulose acetate (e.g., too low a plasticizer content may not reduce the glass transition temperature enough to allow for melt processing) and (ii) maintain desirable mechanical properties of the cellulose acetate (e.g., too high a plasticizer content may reduce the tensile strength of a final composition).

Although a wide variety of plasticizers are known for plasticizing cellulose acetate, including those described in US Pub. No. 2015/0351311, a food grade plasticizer is preferred since numerous classic plasticizers are explicitly prohibited from use in cigarettes, whether traditional or heated. For example, phthalates, phosphorus, and chlorinated plasticizers may be prohibited. As used herein, the term “food grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”) as of Apr. 30, 2017. Food grade plasticizers include triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In further embodiments, the plasticizer is triacetin. In still further aspects, the plasticizer does not contain a phthalate (is “phthalate-free”).

As discussed, the film also optionally comprises a processing aid. When included, the processing aid may be present in an amount from 0.05 to 10 wt. % based on the total weight of the film, e.g., from 0.1 to 5 wt. %, or from 0.5 to 2.5 wt. %. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. In some embodiments, the processing aid is silica. The average particle size of the processing aid may vary. In some aspects, the processing aid may have an average particle size from 0.01 to 50 μm, e.g., from 0.02 microns to 40 microns, from, from 0.05 microns to 30 microns. The particle size may be determined, for example, by sieve analysis.

A releasing agent may also be included in order to improve releasability of the film, once formed, from a backing sheet or substrate. When included, the releasing agent may be present from 0.01 to 10 wt. % based on the total weight of the film, e.g., from 0.05 to 5 wt. %, from 0.05 to 1 wt. %, or from 0.05 to 0.5 wt. %. The releasing agent is generally included when the film is solvent cast, and is added to the dope. In some embodiments, the releasing agent is a fatty acid, such as stearic acid.

The film is crimped in order to increase surface area and provide improved heat absorption as compared to a film with less surface area. Because of the relative flexibility of the cellulose acetate film, especially as compared to a polylactic acid film, the cellulose acetate film may be highly crimped.

The film may have a thickness from 14 to 700 μm, e.g., from 14 to 150 μm or from 20 to 75 μm. As the thickness of the film is decreased, the heat management of the film improves and the cost decreases. Again, because of the relative flexibility of the cellulose acetate film, especially as compared to a polylactic acid film, the cellulose acetate film may be thin, e.g., less than 50 μm. The thinner the film, the more processing aid may be used.

The film may be glossy or matte, as determined by visual inspection and by standard 20, 60 and 85° measurements. In some aspects, the film is matte. Without being bound by theory, it is believed that the surface area of the film is increased when the film is matte, allowing for improved cooling. In some embodiments, additional components may be added to the film. Such components include a matting agent, though such agent is not necessary to provide a matte film. In some aspects, the matte surface is imparted by the casting or extrusion process. In other aspects, an embossing roller may be used.

The cellulose acetate film may be prepared by one of two general methods: melt extrusion or solvent casting, each of which is described below.

### Melt Extrusion

For melt extrusion, a mixture of cellulose acetate, a plasticizer, and any optional components, such as a processing aid, are combined. The mixture may be formed by combining cellulose acetate, in flake or powder form, with the plasticizer and optional processing aid. In some embodiments, the plasticizer and optional processing aid may be combined with the cellulose acetate using a spray distribution system during the mixing step. In other embodiments, the plasticizer and optional processing aid may be added to the cellulose acetate during the mixing step, either continuously or intermittently. In some embodiments, the powder form of cellulose acetate is preferred while in other embodiments cellulose acetate flake may be used. Without being bound by theory, it is believed that the powder form may lead to a sheet with improved plasticization and uniformity as compared to the flake form.

After forming the mixture comprising cellulose acetate, plasticizer and optional processing aid, the mixture may be melt extruded in a small hole die to form filaments which are then sent to a pelletizer to form pellets. The melt extrusion may be performed at a temperature from 165 to 230° C., e.g., from 165 to 220° C. or from 165 to 210° C. The melt extruder may be a twin screw feeder with co-rotating screws, and may be operated at a screw speed from 100 to 500 rpm, e.g., from 150 to 450 rpm, or from 250 to 350 rpm. The pellets may then be extruded to form a film. The film may then be dried. Once dried, the film may then be crimped using a crimper.

### Solvent Casting

Processes for preparing cellulose acetate films by solvent casting have been described in U.S. Pat. Nos. 2, 232,012 and 3,528,833, the entireties of which are incorporated by reference herein. In general, the solvent casting process comprises casting a mixture, also referred to as a dope, comprising plasticizer, processing aid, releasing agent, and cellulose acetate dissolved in a solvent, e.g., acetone. The components of the mixture and the respective amounts determine the characteristics of the film, which is discussed herein.

The dope may be prepared by dissolving cellulose acetate in a solvent. In some embodiments, the solvent is acetone. In one embodiment, the solvent is selected from the group consisting of ethyl lactate methyl ethyl ketone, and dichlormethane. To improve the solubility of cellulose acetate in acetone, the cellulose acetate and acetone may be continuously added to a first mixer. The mixture may then be sent to a second and/or third mixer to allow for full dissolution of the cellulose acetate in the acetone. The mixers may be continuous mixers that are used in series. It is understood that in some embodiments, one mixer may be sufficient to achieve cellulose acetate dissolution. In other embodiments, two, three, or more mixers (e.g., four mixers, five mixers, or greater than five mixers) may be used in series or in parallel. In yet other embodiments, the cellulose acetate, solvent, and other additives may be combined in one or more blenders, without the use of any mixers.

The dope may then be cast on a casting band and dried to evaporate the solvent to prepare a film. The inclusion of a releasing agent improves the release of the film from the casting band. The film may dried and crimped as described above.

IV. Aerosol-Generating Device

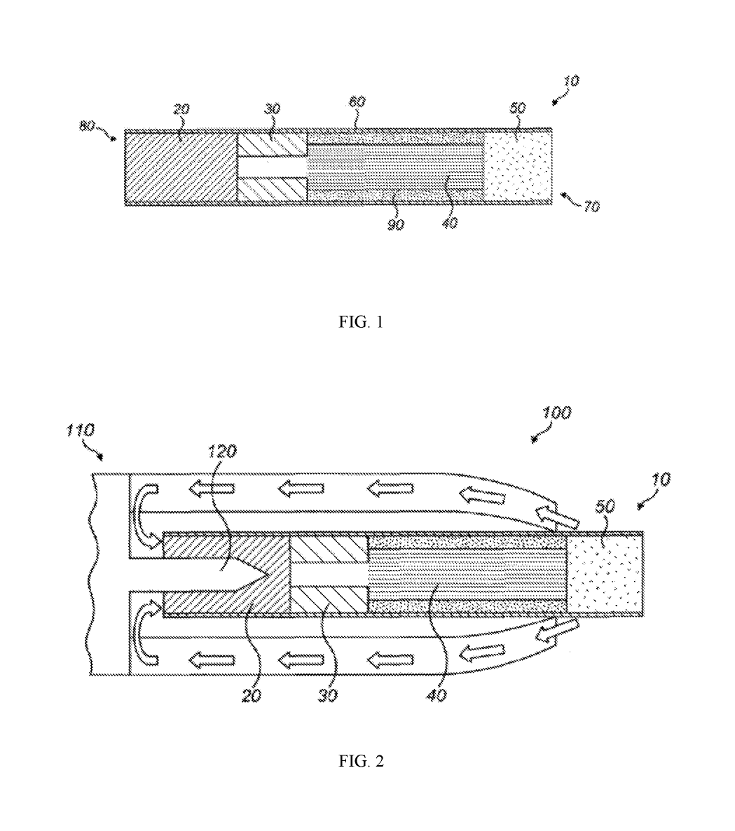

FIG. 1 illustrates an aerosol-generating article 10. The aerosol-generating article 10 comprises four elements arranged in coaxial alignment: an aerosol-forming substrate 20, a support element 30, an aerosol-cooling element 40, and a mouthpiece 50. These four elements are arranged sequentially and are circumscribed by an outer wrapper 60 to form the aerosol-generating article 10. The aerosol-generating 10 has a proximal or mouth end 70, which a user inserts into his or her mouth during use, and a distal end 80 located at the opposite end of the aerosol-generating article 10 to the mouth end 70.

In use, air is drawn through the aerosol-generating article by a user from the distal end 80 to the mouth end 70. The distal end 80 of the aerosol-generating article may also be described as the upstream end of the aerosol-generating article 10 and the mouth end 70 of the aerosol-generating article 10 may also be described as the downstream end of the aerosol-generating article 10. Elements of the aerosol-generating article 10 located between the mouth end 70 and the distal end 80 can be described as being upstream of the mouth end 70 or, alternatively, downstream of the distal end 80.

The aerosol-forming substrate 20 is located at the extreme distal or upstream end of the aerosol-generating article 10. In the embodiment illustrated in FIG. 1, aerosol-forming substrate 20 comprises a gathered sheet of crimped homogenized tobacco material circumscribed by a wrapper. The crimped sheet of homogenized tobacco material may comprise an aerosol-former—such as glycerin.

The support element 30 is located immediately downstream of the aerosol-forming substrate 20 and abuts the aerosol-forming substrate 20. In the embodiment shown in FIG. 1, the support element is a hollow cellulose acetate tube. The support element 30 locates the aerosol-forming substrate 20 at the extreme distal end 80 of the aerosol-generating article 10 so that it can be penetrated by a heating element of an aerosol-generating device. As described further below, the support element 30 acts to prevent the aerosol-forming substrate 20 from being forced downstream within the aerosol-generating article 10 towards the aerosol-cooling element 40 when a heating element of an aerosol-generating device is inserted into the aerosol-forming substrate 20. The support element 30 also acts as a spacer to space the aerosol-cooling element 40 of the aerosol-generating article 10 from the aerosol-forming substrate 20.

As shown, the aerosol-cooling element 40 is located immediately downstream of the support element 30 and abuts the support element 30. In use, volatile substances released from the aerosol-forming substrate 20 pass along the aerosol-cooling element 40 towards the mouth end 70 of the aerosol-generating article 10. The volatile substances may cool within the aerosol-cooling element 40 to form an aerosol that is inhaled by the user. In the embodiment illustrated in FIG. 1, the aerosol-cooling element comprises a crimped cellulose acetate film circumscribed by a wrapper 90. The crimped cellulose acetate defines a plurality of longitudinal channels that extend along the length of the aerosol-cooling element 40.

The mouthpiece 50 is located immediately downstream of the aerosol-cooling element 40 and abuts the aerosol-cooling element 40. As shown in FIG. 1, the mouthpiece 50 comprises a conventional cellulose acetate tow filter.

To assemble the aerosol-generating article 10, the four elements described above are aligned and tightly wrapped within the outer wrapper 60. In the embodiment illustrated in FIG. 1, the outer wrapper is a conventional cigarette paper. As shown in FIG. 1, an optional row of perforations is provided in a region of the outer wrapper 60 circumscribing the support element 30 of the aerosol-generating article 10.

As shown in FIG. 1, a distal end portion of the outer wrapper 60 of the aerosol-generating article 10 is circumscribed by a band of tipping paper (not shown).

The aerosol-generating article 10 illustrated in FIG. 1 is designed to engage with an aerosol-generating device comprising a heating element in order to be consumed by a user. In use, the heating element of the aerosol-generating device heats the aerosol-forming substrate 20 of the aerosol-generating article 10 to a sufficient temperature to volatilize compounds that are capable of forming an aerosol, which is drawn downstream through the aerosol-generating article 10 and inhaled by the user.

FIG. 2 illustrates a portion of an aerosol-generating system 100 comprising an aerosol-generating device 110 and an aerosol-generating article 10 according to the embodiment described above and illustrated in FIG. 1.

The aerosol-generating device comprises a heating element 120. As shown in FIG. 2, the heating element 120 is mounted within an aerosol-generating article receiving chamber of the aerosol-generating device 110. In use, the user inserts the aerosol-generating article 10 into the aerosol-generating article receiving chamber of the aerosol-generating device 110 so that the heating element 120 is directly inserted into the aerosol-forming substrate 20 of the aerosol-generating article 10 as shown in FIG. 2. In the embodiment shown in FIG. 2, the heating element 120 of the aerosol-generating device 110 is a heater blade.

The aerosol-generating device 110 comprises a power supply and electronics (not shown) that allow the heating element 120 to be actuated. Such actuation may be manually operated or may occur automatically in response to a user drawing on an aerosol-generating article 10 inserted into the aerosol-generating article receiving chamber of the aerosol-generating device 110. A plurality of openings is provided in the aerosol-generating device to allow air to flow to the aerosol-generating article 10; the direction of air flow is illustrated by arrows in FIG. 2.

The support element 40 of the aerosol-generating article 10 resists the penetration force experienced by the aerosol-generating article 10 during insertion of the heating element 120 of the aerosol-generating device 110 into the aerosol-forming substrate 20. The support element 40 of the aerosol-generating article 10 thereby resists downstream movement of the aerosol-forming substrate within the aerosol-generating article 10 during insertion of the heating element of the aerosol-generating device into the aerosol-forming substrate.

Once the internal heating element 120 is inserted into the aerosol-forming substrate 10 of the aerosol-generating article 10 and actuated, the aerosol-forming substrate 20 of the aerosol-generating article 10 is heated to a temperature of less than about 400 degrees Celsius (or other temperature as discussed herein) by the heating element 120 of the aerosol-generating device 110. At this temperature, volatile compounds are evolved from the aerosol-forming substrate 20 of the aerosol-generating article 10. As a user draws on the mouth end 70 of the aerosol-generating article 10, the volatile compounds evolved from the aerosol-forming substrate 20 are drawn downstream through the aerosol-generating article 10 and condense to form an aerosol that is drawn through the mouthpiece 50 of the aerosol-generating article 10 into the user's mouth.

As the aerosol passes downstream thorough the aerosol-cooling element 40, the temperature of the aerosol can be reduced due to transfer of thermal energy from the aerosol to the aerosol-cooling element 40. When the aerosol enters the aerosol-cooling element 40, its temperature is approximately 60° C. Due to cooling within the aerosol-cooling element 40, the temperature of the aerosol as it exits the aerosol-cooling element is approximately 40° C.

The present invention will be better understood in view of the following non-limiting example.

### EXAMPLE

### Example 1

Five cellulose acetate films of varied thicknesses were prepared by solvent casting. A single dope was formed by dissolving cellulose acetate in acetone. Triacetin was added as a plasticizer, silica was added as a processing aid, and stearic acid was added as a releasing agent. The dope was then cast to form films of thicknesses specified in Table 1 below, and dried to evaporate the acetone. The film contained 14.6 wt. % triacetin, 85 parts cellulose acetate, approximately 0.3 wt. % silica, and less than 0.1 wt. % stearic acid. Properties of the films are reported in Table 1. Tensile strength was measured according to ASTM D862. Transparency was measured according to ASTM D1746. Haze was measured according to ASTM D1003.

TABLE 1

| | Ex. 1 | Ex. 2 | Ex. 3 | Ex. 4 | Ex. 5 |
|---|---|---|---|---|---|
| Thickness (μm) | 14 | 24 | 50 | 75 | 95 |
| Finish | Gloss | Gloss | Gloss | Gloss | Gloss |
| Glass Transition | | | | | |
| Temperature | 120 | 120 | 120 | 120 | 120 |
| (approximate) (° C.) | | | | | |
| Transparency (%) | 92.1 | 92.7 | 91.4 | 91.5 | 90.4 |
| Haze (%) | 0.7 | 0.7 | 0.8 | 1.1 | 0.9 |
| Tensile Strength | 80-100 | 80-100 | 80-100 | 80-100 | 80-100 |
| (N/mm²) | | | | | |

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention. All US patents cited herein are incorporated by reference in their entirety.

We claim:

1. An aerosol-generating device comprising:
an aerosol-generating article, wherein the aerosol-generating article comprises:
an aerosol-forming substrate,
a support element;
an aerosol-cooling element comprising a crimped cellulose acetate film; and
a mouthpiece
wherein the cellulose acetate film comprises cellulose acetate and a plasticizer.

2. The device of claim 1, wherein the cellulose acetate film has a thickness from 14 to 700 μm.

3. The device of claim 1, wherein the cellulose acetate film has a thickness from 14 to 150 μm.

4. The device of claim 1, wherein the cellulose acetate film has a thickness of 20 to 75 μm.

5. The device of claim 1, wherein the cellulose acetate film has a thickness of less than 50 μm.

6. The device of claim 1, wherein the cellulose acetate film further comprises a processing aid.

7. The device of claim 6, wherein the processing aid is selected from the group consisting of titanium dioxide, aluminum oxide, zirconium oxide, silicon dioxide, calcium carbonate, calcium silicate, aluminum silicate, magnesium silicate, calcium phosphate and mixtures thereof.

8. The device of claim 6, wherein the processing aid is present from 0.05 to 10 wt. %, based on the total weight of the film.

9. The device of claim 1, wherein the plasticizer is a food-grade plasticizer.

10. The device of claim 1, wherein the plasticizer is selected from the group consisting of diacetin, tripropionin, trimethyl citrate, tributyl citrate, triethyl citrate, eugenol, cinnamyl alcohol, alkyl lactones, methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof.

11. The device of claim 1, wherein the plasticizer is triacetin.

12. The device of claim 1, wherein the plasticizer is phthalate-free.

13. The device of claim 1, wherein the cellulose acetate film comprises from 0.5 to 40 wt. % plasticizer, based on the total weight of the film.

14. The device of claim 1, wherein the cellulose acetate film comprises from 1 to 35 wt. % plasticizer, based on the total weight of the film.

15. The device of claim 1, wherein the cellulose acetate film further comprises a releasing agent.

16. The device of claim 15, wherein the releasing agent is a fatty acid.

17. The device of claim 16, wherein the fatty acid is stearic acid.

18. The device of claim 1, further comprising a heating element.

19. A method of forming an aerosol-generating article, the method comprising:
(a) forming a cellulose acetate dope comprising cellulose acetate, a solvent, and a plasticizer;
(b) casting the cellulose acetate dope and evaporating the solvent to form a cellulose acetate film;
(c) crimping the cellulose acetate film to form an aerosol-cooling element;
(d) aligning a mouthpiece, the aerosol-cooling element, a support element, and an aerosol-forming substrate; and
(e) circumferentially wrapping an outer wrapper around the mouthpiece, the aerosol-cooling element, the support element, and the aerosol-forming substrate.

20. A method of forming an aerosol-generating article, the method comprising:
(a) forming a mixture of cellulose acetate and plasticizer, wherein the mixture comprises from 20 to 40 wt. % plasticizer, based on the total weight of the mixture;
(b) extruding the mixture at a temperature up to 230° C. to form a cellulose acetate pellet;
(c) extruding the pellet to form a cellulose acetate film;
(d) crimping the cellulose acetate film to form an aerosol-cooling element;
(e) aligning a mouthpiece, the aerosol-cooling element, a support element, and an aerosol-forming substrate; and
(f) circumferentially wrapping an outer wrapper around the mouthpiece, the aerosol-cooling element, the support element, and the aerosol-forming substrate.
